(19) United States
(12) Patent Application Publication
(10) Pub. No.: US 2026/0296574 A1
(43) Pub. Date: Oct. 1, 2026

(54) TRAVELING WIND CONTROL DEVICE

(71) Applicant: SUBARU CORPORATION, Tokyo (JP)

(72) Inventor: Yuji FUJIU, Tokyo (JP)

(21) Appl. No.: 19/556,659

(22) Filed: Mar. 4, 2026

(30) Foreign Application Priority Data
Mar. 31, 2025 (JP) 2025-058655

(51) Int. Cl. B62D 35/02

(52) U.S. Cl. CPC B62D 35/02

(57) ABSTRACT

A traveling wind control device is configured to control a flow of traveling wind at a lower portion of a vehicle that travels. The traveling wind control device includes a traveling wind path, a front opening portion, a first rear opening portion, and a second rear opening portion. The traveling wind path is provided up to a rear side of a rear tire from a location situated inwardly of the rear tire in a vehicle width direction. The front opening portion is provided on a front end side of the traveling wind path. The first rear opening portion is provided on a rear end side of the traveling wind path and opens rearward. The second rear opening portion is provided on the rear end side of the traveling wind path and opens downward.

### CROSS-REFERENCE TO RELATED APPLICATIONS

The present application claims priority from Japanese Patent Application No. 2025-058655 filed on Mar. 31, 2025, the entire contents of which are hereby incorporated by reference.

### BACKGROUND

The disclosure relates to a traveling wind control device that controls a blow path of traveling wind at a vehicle body.

As a vehicle travels, traveling wind passes the surrounding of a vehicle body. When considering aerodynamic characteristics and steering performance, control of the traveling wind may be important. A disclosure in which, for example, aerodynamic performance is improved by controlling traveling wind is described in the patent documents below.

Japanese Unexamined Patent Application Publication (JP-A) No. 2017-100586 describes a vehicle-lower-portion air flow control device. The vehicle-lower-portion air flow control device has an undercover opening portion, a bumper opening portion that is positioned closer to a rear side of a vehicle than the undercover opening portion and on an upper side of the vehicle, an air flow path that causes the undercover opening portion and the bumper cover opening portion to communicate with each other, and an opening-closing plate. This makes it possible for an airflow that flows below the vehicle when the vehicle travels to be guided toward the upper side of the vehicle.

JP-A No. 2003-276454 describes an engine cooling device of a rear engine car. For example, the engine cooling device has an inlet, an outlet, a duct that forms an air flow path between the inlet and the outlet, a radiator that is provided at an intermediate portion of the duct, and a valve member that opens and closes the outlet that opens rearward. This makes it possible for cooling air that has passed the radiator to be discharged rearward at the time of ordinary travel, and to be discharged mainly downward at the time of low-speed travel or when a vehicle is stopped.

JP-A No. 2005-170304 describes an aerodynamic characteristics improving device of a vehicle. For example, the aerodynamic characteristics improving device includes an air duct that has an air inlet and an air outlet. The air inlet is provided at a portion of a front end of the vehicle facing a region where air pressure becomes higher than atmospheric pressure when the vehicle travels forward. The air outlet is provided at a downwardly and upwardly inclined portion of a rear portion of a vehicle body. When the vehicle travels at a high speed, air that has been taken into the air duct through the air inlet due to a pressure difference between the air inlet and the air outlet is ejected to the portion via the air outlet. By decreasing the size of a separation region of traveling wind that is generated at the portion and by decreasing swirls that are generated at the rear of the vehicle, the aerodynamic characteristics of the vehicle are improved.

### SUMMARY

An aspect of the disclosure provides a traveling wind control device configured to control a flow of traveling wind at a lower portion of a vehicle that travels. The traveling wind control device includes a traveling wind path, a front opening portion, a first rear opening portion, and a second rear opening portion. The traveling wind path is provided up to a rear side of a rear tire from a location situated inwardly of the rear tire in a vehicle width direction. The front opening portion is provided on a front end side of the traveling wind path. The first rear opening portion is provided on a rear end side of the traveling wind path and opens rearward. The second rear opening portion is provided on the rear end side of the traveling wind path and opens downward.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a side view illustrating a vehicle including traveling wind control devices according to an embodiment of the disclosure;

FIG. 2 is a bottom view partially illustrating a vehicle lower portion of the vehicle including the traveling wind control devices according to the embodiment of the disclosure;

FIG. 3 is a cross-sectional view partially illustrating the vehicle including the traveling wind control devices according to the embodiment of the disclosure;

FIG. 4 is a cross-sectional view partially illustrating the vehicle including the traveling wind control devices according to the embodiment of the disclosure;

FIG. 5 is a block diagram illustrating a connection structure of one traveling wind control device according to the embodiment of the disclosure;

FIG. 6 is a flowchart illustrating an operation of each traveling wind control device according to the embodiment of the disclosure;

FIG. 7A is a cross-sectional view illustrating a first operation mode of one traveling wind control device according to the embodiment of the disclosure;

FIG. 7B is a bottom view illustrating the first operation mode of the traveling wind control device according to the embodiment of the disclosure;

FIG. 8A is a cross-sectional view illustrating a second operation mode of one traveling wind control device according to the embodiment of the disclosure;

FIG. 8B is a bottom view illustrating the second operation mode of the traveling wind control device according to the embodiment of the disclosure;

FIG. 9A is a cross-sectional view illustrating another operation mode of one traveling wind control device according to the embodiment of the disclosure;

FIG. 9B is a bottom view illustrating the other operation mode of the traveling wind control device according to the embodiment of the disclosure; and

FIG. 10 is a graph illustrating characteristics of each traveling wind control device according to the embodiment of the disclosure.

### DETAILED DESCRIPTION

In the disclosures that have been described in the respective patent documents above, there is room for improvement from the viewpoint of further improving, for example, the aerodynamic characteristics when a vehicle travels.

For example, when a vehicle travels, traveling wind is generated even on a lower side of a vehicle body. Such traveling wind is sometimes called “underfloor flow”. On the lower side of the vehicle body, in the vicinity of a central portion in a vehicle width direction, since blocking objects that block the traveling wind do not exist, the traveling wind flows at a high speed. In contrast, on the lower side of the vehicle body, on a rear side of a rear tire, since the rear tire acts as a blocking object that blocks the flow of the traveling wind, the traveling wind flows at a relatively low speed. Therefore, at the rear of the vehicle, the traveling wind that blows rearward from the lower side of the vehicle body swirls up and a swirl is formed, as a result of which the vehicle body is pulled rearward and air resistance is increased.

It is desirable to provide a traveling wind control device that can decrease air resistance when a vehicle travels.

Details of each traveling wind control device 20 and a vehicle 10 according to an embodiment of the disclosure are described below with reference to the drawings. Although in the description below, a forward direction, a rearward direction, an upward direction, a downward direction, a leftward direction, and a rightward direction are used, left and right refer to left and right when the vehicle 10 is viewed from the rear. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

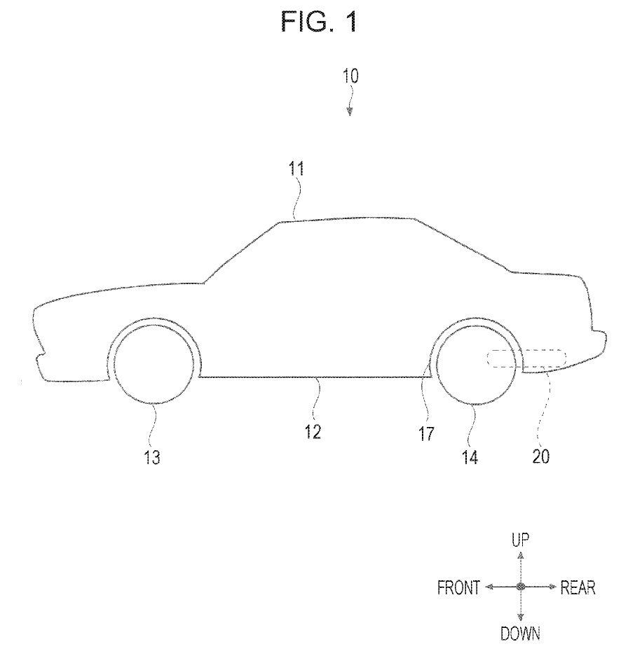

FIG. 1 is a side view illustrating the vehicle 10 including traveling wind control devices 20.

Examples of the vehicle 10 include an engine car, a BEV (Battery Electric Vehicle), an HEV (Hybrid Electric Vehicle), and a PHEV (Plug-in Hybrid Electric Vehicle).

The vehicle 10 includes a vehicle body 11. The vehicle body 11 is provided with front tires 13 and rear tires 14. The front tires 13 and the rear tires 14 are disposed in respective tirehoods 17. Since the rear tires 14 are provided, when the vehicle 10 travels, traveling wind swirls are formed at the rear of the rear tires 14, which may influence aerodynamic performance. In the embodiment, since each traveling wind control device 20 that is described below is provided, the formation of such swirls is suppressed and the aerodynamic performance is improved.

The vehicle body 11 includes a vehicle lower portion 12. The vehicle lower portion 12 is a portion that forms a lower surface of the vehicle body 11 and the vicinity thereof. To decrease air resistance, the lower surface of the vehicle lower portion 12 has a shape in which formation of a protrusion is suppressed.

Each traveling wind control device 20 is a device that is disposed at a rear portion of the vehicle lower portion 12 to improve the aerodynamic performance of the vehicle 10. The traveling wind control devices 20 are disposed on rear sides of the respective rear tires 14. For example, a front end portion of each traveling wind control device 20 is disposed forwardly of a rear end portion of a corresponding one of the rear tires 14. A rear end portion of each traveling wind control device 20 is disposed rearwardly of the rear end portion of the corresponding one of the rear tires 14.

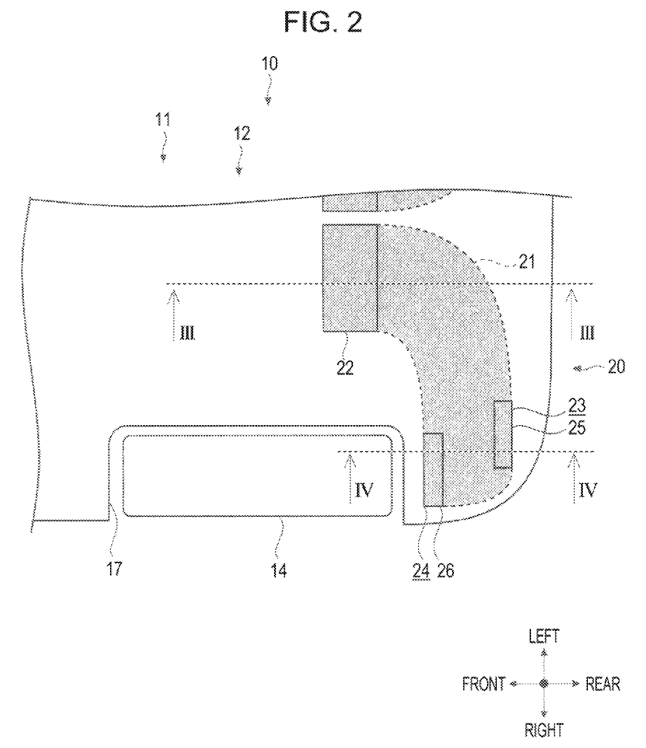

FIG. 2 is a bottom view partially illustrating the vehicle lower portion 12 of the vehicle 10 including the traveling wind control devices 20. Here, a structure of the traveling wind control device 20 that is disposed on a right side of a rear portion of the vehicle body 11 is illustrated and described. The other traveling wind control device 20 that has a structure that is the same as the structure illustrated in FIG. 2 is disposed on a left side of the rear portion of the vehicle body 11.

The traveling wind control device 20 is a device that controls the flow of traveling wind at the lower portion of the vehicle 10 that travels. The traveling wind control device 20 primarily includes a traveling wind path 21, a front opening portion 22, a first rear opening portion 23, and a second rear opening portion 24. Further, the traveling wind control device 20 includes a vehicle-speed sensor 15, a first opening-closing member 25, a second opening-closing member 26, and an operation controller 16, which are described below.

The traveling wind path 21 is a wind tunnel that is provided so to be curved from a location situated inwardly of the rear tire 14 in a vehicle width direction to the rear side of the rear tire 14. For example, as the traveling wind path b, a duct provided from a synthetic resin plate can be used. A front end portion of the traveling wind path 21 is disposed inwardly of the rear tire 14 in the vehicle width direction, and is disposed forwardly of a rear end of the rear tire 14 in the forward direction and the rearward direction. A rear end portion of the traveling wind path 21 is disposed rearwardly of the rear tire 14. Therefore, the traveling wind path 21 has a shape that is curved rightward toward the rear.

The front opening portion 22 is an opening that is provided on a front end side of the traveling wind path 21. The front opening portion 22 is an opening that causes the front end portion of the traveling wind path 21 and the outside of the vehicle to communicate with each other. The front opening portion 22 has a substantially rectangular shape. As described below, when the vehicle 10 travels, traveling wind is introduced into the traveling wind path 21 through the front opening portion 22.

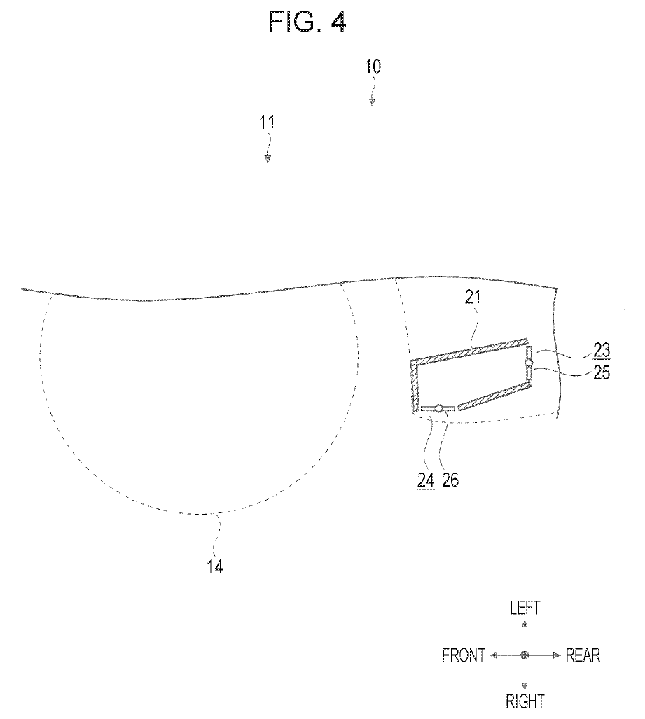

The first rear opening portion 23 is an opening that is provided on a rear end side of the traveling wind path 21 and that opens rearward. The first rear opening portion 23 is an opening that causes the rear end portion of the traveling wind path 21 and the outside of the vehicle to communicate with each other. As described below, when the vehicle 10 travels, traveling wind blows rearward out of the first rear opening portion 23. When the vehicle travels, causing the traveling wind to be blown rearward out of the first rear opening portion 23 makes it possible to, on a rear side of the rear tire 14, increase the flow speed of the traveling wind and improve aerodynamic performance. The first rear opening portion 23 is provided with the first opening-closing member 25. The first opening-closing member 25 is described below with reference to FIG. 4.

The second rear opening portion 24 is an opening that is provided on the rear end side of the traveling wind path 21 and that opens downward. The first rear opening portion 23 is an opening that causes the rear end portion of the traveling wind path 21 and the outside of the vehicle to communicate with each other. When the vehicle 10 travels, traveling wind blows downward out of the second rear opening portion 24. When the vehicle travels, causing the traveling wind to be ejected downward out of the second rear opening portion 24 makes it possible to suppress swirling up of powder dust caused by the rear tire 14 that rotates and to suppress adhesion of dust to a rear window. The second rear opening portion 24 is provided with the second opening-closing member 26. The second opening-closing member 26 is described below with reference to FIG. 4.

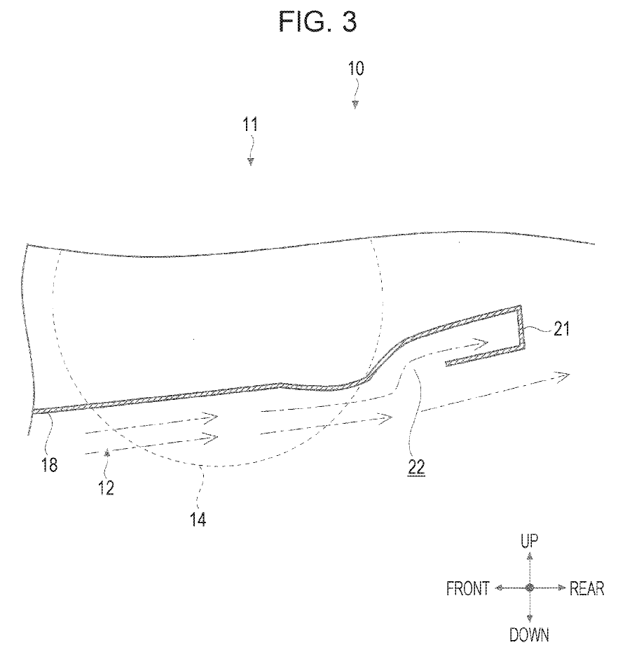

FIG. 3 is a cross-sectional view partially illustrating the vehicle 10 including the traveling wind control devices 20. FIG. 3 is a cross-sectional view along cross-sectional line III-III of FIG. 2. The cross section along the line III-III is a cross section including the forward direction and the rearward direction, and the upward direction and the downward direction. In FIG. 3 and subsequent figures, traveling wind that is generated when the vehicle 10 travels is indicated by alternate long and short dash lines.

As described above, the front opening portion 22 is provided at a front end of the traveling wind path 21. The front opening portion 22 is a portion that opens downward. Here, the front opening portion 22 is always in an open state. However, the front opening portion 22 can be provided with an opening-closing member that opens and closes the front opening portion 22. As the opening-closing member, a structure that is the same as, for example, the second opening-closing member 26 (described below) can be used.

When the vehicle 10 travels, high-speed traveling wind is generated between the vehicle lower portion 12 and the ground. Part of the traveling wind is introduced into the traveling wind path 21 through the front opening portion 22.

FIG. 4 is a cross-sectional view partially illustrating the vehicle 10 including the traveling wind control devices 20. FIG. 4 is a cross-sectional view along cross-sectional line IV-IV of FIG. 2. The cross section along the line IV-IV is a cross section including the forward direction and the rearward direction, and the upward direction and the downward direction.

The rear end of the traveling wind path 21 is provided with the first opening-closing member 25 and the second opening-closing member 26.

The first opening-closing member 25 has a structure that brings the first rear opening portion 23 into an open state or a closed state. As a mechanism that performs an opening operation and a closing operation by using the first opening-closing member 25, for example, a rotary or a sliding mechanism can be used. Here, as the first opening-closing member 25, a rotary damper is used. For example, an intermediate portion of the first opening-closing member 25 is provided with a rotary shaft, and the first opening-closing member 25 can rotate upon the rotary shaft as a rotation center. The first opening-closing member 25 is rotated by driving by an actuator, such as a motor. The first rear opening portion 23 is an opening portion that opens rearward. Therefore, when the first opening-closing member 25 is a perpendicular member, the first opening-closing member 25 brings the first rear opening portion 23 into the closed state and thus traveling wind is not blown rearward out of the first rear opening portion 23. In contrast, when the first opening-closing member 25 is rotated and brought into a horizontal state, the first opening-closing member 25 brings the first rear opening portion 23 into the open state and thus the traveling wind blows rearward out of the first rear opening portion 23.

The second opening-closing member 26 has a structure that brings the second rear opening portion 24 into an open state or a closed state. As a mechanism that performs an opening operation and a closing operation by using the second opening-closing member 26, as with the first opening-closing member 25, for example, a rotary or a sliding mechanism can be used. Here, as the second opening-closing member 26, a rotary damper is used. For example, an intermediate portion of the second opening-closing member 26 is provided with a rotary shaft, and the second opening-closing member 26 can rotate upon the rotary shaft as a rotation center. The second opening-closing member 26 is rotated by driving by an actuator, such as a motor. The second rear opening portion 24 is an opening portion that opens downward. Therefore, when the second opening-closing member 26 is a horizontal member, the second opening-closing member 26 brings the second rear opening portion 24 into the closed state and thus traveling wind is not blown downward out of the second rear opening portion 24. In contrast, when the second opening-closing member 26 is rotated and brought into a perpendicular state, the second opening-closing member 26 brings the second rear opening portion 24 into the open state and thus the traveling wind blows downward out of the second rear opening portion 24.

The first rear opening portion 23 is disposed rearward of the second rear opening portion 24. The first rear opening portion 23 opens rearward. As illustrated in FIG. 2, the first rear opening portion 23 has a substantially rectangular shape having a longitudinal direction along the vehicle width direction. The first rear opening portion 23 is provided at the rear of the rear tire 14. Therefore, when the vehicle 10 travels, it is possible to more effectively discharge high-speed traveling wind rearward out of the first rear opening portion 23. The second rear opening portion 24 is disposed near the rear tire 14. Therefore, the rising of powder dust that is blown up due to the rotation of the rear tire 14 can be more effectively held down by traveling wind that blows downward out of the second rear opening portion 24.

The second rear opening portion 24 is disposed below the first rear opening portion 23. The second rear opening portion 24 opens downward. As illustrated in FIG. 2, the second rear opening portion 24 has a substantially rectangular shape having a longitudinal direction along the vehicle width direction. Here, with reference to FIG. 2, a left side end portion of the second rear opening portion 24 may be disposed leftward of a left side end portion of the rear tire 14. Further, a right side end portion of the second rear opening portion 24 may be disposed leftward of a right side end portion of the rear tire 14. As a result, as described below, the rising of powder dust that is blown up due to the rotation of the rear tire 14 can be more effectively held down by traveling wind that blows out of the second rear opening portion 24.

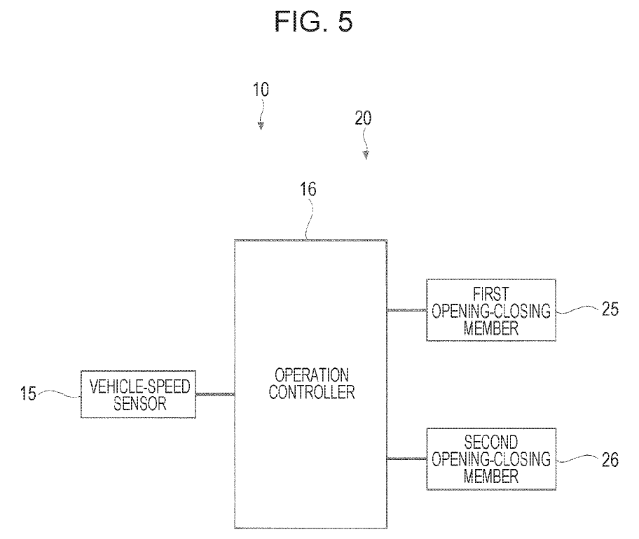

FIG. 5 is a block diagram illustrating a connection structure of one traveling wind control device 20. The traveling wind control device 20 includes the operation controller 16, the vehicle-speed sensor 15, the first opening-closing member 25, and the second opening-closing member 26. The vehicle-speed sensor 15 is connected with an input-side terminal of the operation controller 16. The first opening-closing member 25 and the second opening-closing member 26 are connected with an output-side terminal of the operation controller 16.

The vehicle-speed sensor 15 has a structure that detects the travel speed of the vehicle 10 that travels. The vehicle-speed sensor 15 transmits information indicating the travel speed of the vehicle 10 to the operation controller 16.

The first opening-closing member 25 is a device that brings the above-described first rear opening portion 23 into the open state or the closed state as appropriate. As described above, the first opening-closing member 25 opens and closes the first rear opening portion 23 based on an instruction signal that is provided by the operation controller 16.

The second opening-closing member 26 is a device that brings the above-described second rear opening portion 24 into the open state or the closed state as appropriate. As described above, the second opening-closing member 26 opens and closes the second rear opening portion 24 based on an instruction signal that is provided by the operation controller 16.

The operation controller 16 includes, for example, a semiconductor element of a CPU (Central Processing Unit) or the like. The operation controller 16 may include a semiconductor memory device in which, as a memory, for example, RAM (Random Access Memory) or ROM (Read Only Memory) is used. Such a memory stores, for example, a program or a parameter. The operation controller 16 executes functions or methods (described below) based on, for example, a program or a parameter read out from the memory.

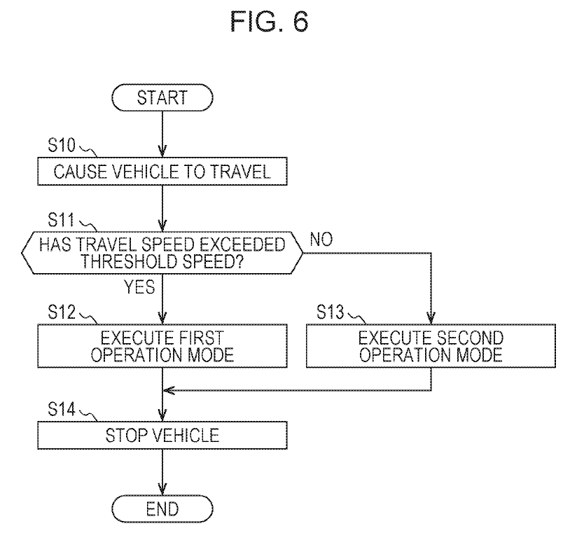

For example, the operation controller 16 changes the opening degree of the first opening-closing member 25 or the opening degree of the second opening-closing member 26 based on the travel speed. In a first operation mode (described below), the operation controller 16 decreases the opening degree of the first opening-closing member 25 as the travel speed increases. Further, when the travel speed exceeds a predetermined threshold speed, the operation controller 16 executes the first operation mode, and when the travel speed is less than or equal to the threshold speed, the operation controller 16 executes a second operation mode (described below). In the first operation mode, the operation controller 16 brings the first rear opening portion 23 into the open state by using the first opening-closing member 25, and brings the second rear opening portion 24 into the closed state by using the second opening-closing member 26. Further, in the second operation mode, the operation controller 16 brings the first rear opening portion 23 into the closed state by using the first opening-closing member 25 and brings the second rear opening portion 24 into the open state by using the second opening-closing member 26. Such functions of the operation controller 16 are described below with reference to, for example, FIG. 6.

FIG. 6 is a flowchart illustrating an operation of each traveling wind control device 20. Based on FIG. 6, the operation of each traveling wind control device 20 is described below also with reference to each figure mentioned above.

In Step S10, the operation controller 16 causes the vehicle 10 to travel. For example, with reference to FIG. 1, based on an instruction of an occupant or the operation controller 16, the front tire 13 and the rear tire 14 are rotated by a driving force of an engine or a motor, which are installed at the vehicle body 11. This causes the vehicle 10 to travel. As the vehicle 10 travels, traveling wind is generated. The traveling wind flows rearward along a surface of the vehicle body 11. Part of the traveling wind flows between the vehicle lower portion 12 and the ground.

In Step S11, the operation controller 16 determines whether the travel speed of the vehicle 10 detected by the vehicle-speed sensor 15 exceeds the predetermined threshold speed.

If it is YES in Step S11, that is, if the travel speed has exceeded the threshold speed, the operation controller 16 determines that the vehicle 10 is traveling at a high speed, and proceeds to Step S12.

If it is NO in Step S11, that is, if the travel speed is less than or equal to the threshold speed, the operation controller 16 determines that the vehicle 10 is traveling at a low speed, and proceeds to Step S13.

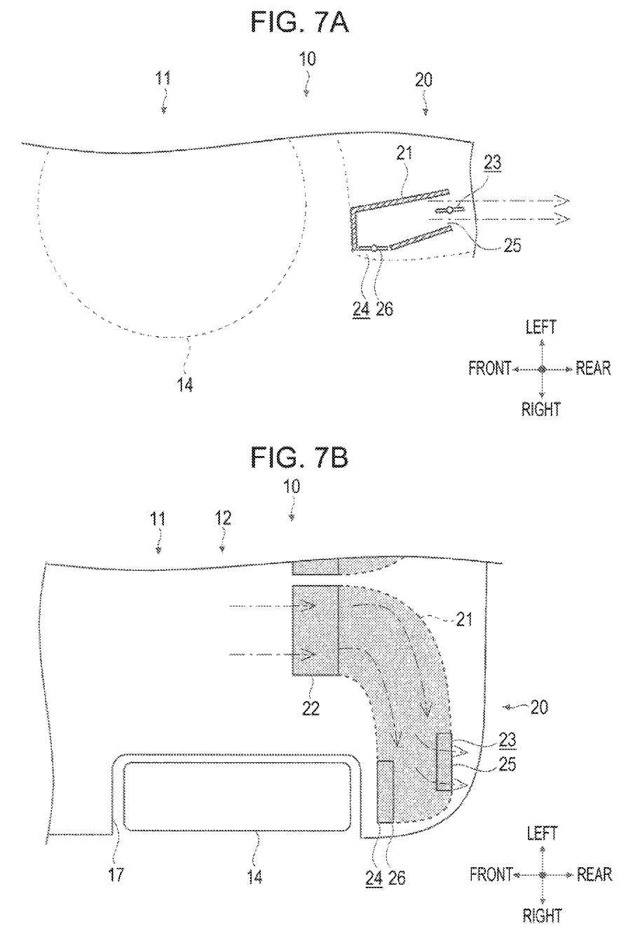

In Step S12, the operation controller 16 executes the first operation mode when the vehicle 10 is traveling at a high speed. Step S12 is described with reference to FIGS. 7A and 7B. FIG. 7A is a cross-sectional view illustrating the first operation mode of one traveling wind control device 20. FIG. 7B is a bottom view illustrating the first operation mode of the traveling wind control device 20.

With reference to FIG. 7A, in the first operation mode, the operation controller 16 brings the first rear opening portion 23 into the open state by using the first opening-closing member 25, and brings the second rear opening portion 24 into the closed state by using the second opening-closing member 26. Here, the front opening portion 22 illustrated in FIG. 7B is in the open state.

When the vehicle 10 travels at a high speed in this state, as illustrated in FIG. 7B, traveling wind is introduced into the traveling wind path 21 through the front opening portion 22. The traveling wind introduced into the traveling wind path 21 blows along the curved shape of the traveling wind path 21 toward the rear right. Thereafter, the traveling wind blows rearward out of the first rear opening portion 23. As illustrated in FIG. 7A, when the first opening-closing member 25 is brought into a horizontal state, the first rear opening portion 23 is in the open state. Therefore, the traveling wind blows rearward at a high speed out of the first rear opening portion 23. At this time, the second rear opening portion 24 is in the closed state.

Therefore, the flow speed of traveling wind on a rear side of the rear tire 14 can be made substantially the same as the flow speed of traveling wind flowing rearward from a width-direction intermediate portion of the vehicle lower portion 12. Consequently, traveling wind swirls are suppressed from being formed at the rear of the vehicle 10. Thus, it is possible to improve aerodynamic performance when the vehicle 10 travels.

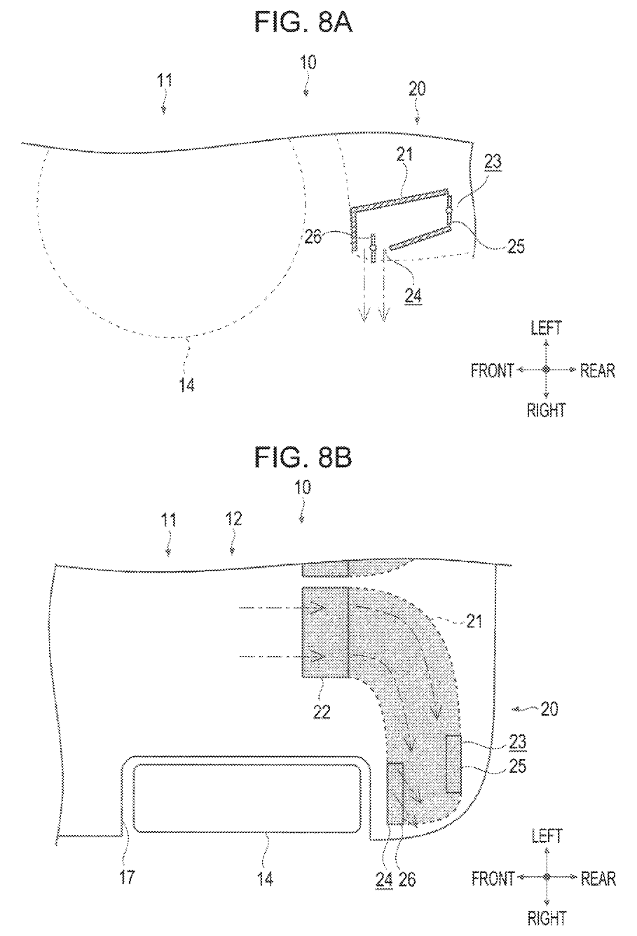

In Step S13, the operation controller 16 executes the second operation mode when the vehicle 10 is traveling at a low speed. Here, “is traveling at a low speed” includes a case in which the vehicle 10 is traveling at a low speed on a paved road and a case in which the vehicle 10 is traveling at a low speed on an unpaved road. Step S13 is described with reference to FIGS. 8A and 8B. FIG. 8A is a cross-sectional view illustrating the second operation mode of one traveling wind control device 20. FIG. 8B is a bottom view illustrating the second operation mode of the traveling wind control device 20.

With reference to FIG. 8A, in Step S13, the operation controller 16 brings the first rear opening portion 23 into the closed state by causing the first opening-closing member 25 to be a perpendicular member. In contrast, the operation controller 16 brings the second rear opening portion 24 into the open state by causing the second opening-closing member 26 to be a perpendicular member.

When the vehicle 10 travels at a low speed in this state, as illustrated in FIG. 8B, traveling wind is introduced into the traveling wind path 21 through the front opening portion 22. The traveling wind introduced into the traveling wind path 21 blows along the curved shape of the traveling wind path 21 to the rear right. Thereafter, the traveling wind blows downward out of the second rear opening portion 24. As illustrated in FIG. 8A, after the traveling wind has been blown downward out of the second rear opening portion 24, even if powder dust swirls up due to the rotation of the rear tire 14, the traveling wind holds down the powder dust. Therefore, it is possible to suppress adhesion of the powder dust to the rear window of the vehicle 10. At this time, the first rear opening portion 23 is in the closed state.

In Step S14, the vehicle 10 is stopped based on an instruction of the operation controller 16.

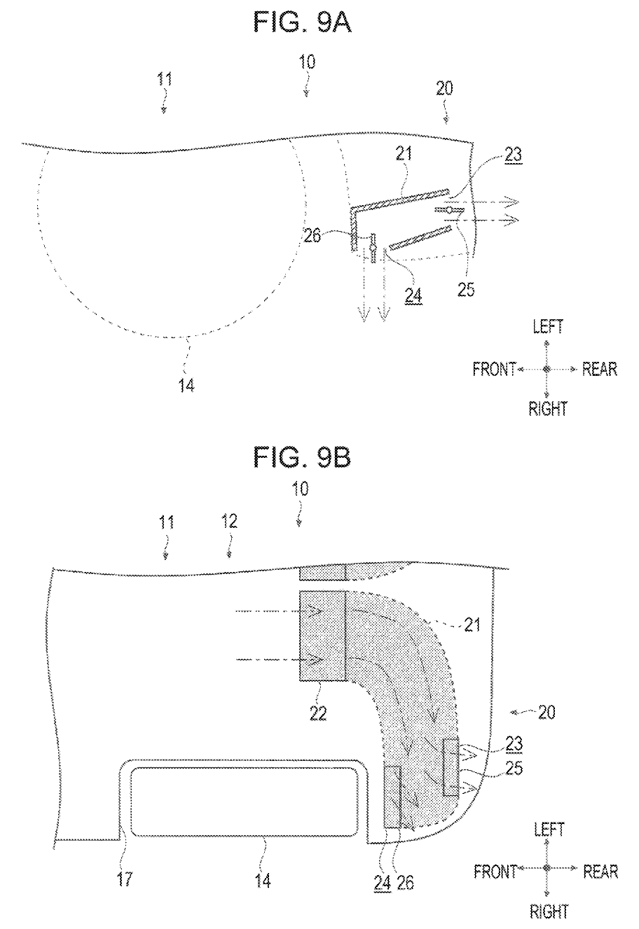

FIG. 9A is a cross-sectional view illustrating another operation mode of one traveling wind control device 20. FIG. 9B is a bottom view illustrating the other operation mode of the traveling wind control device 20. Here, the first rear opening portion 23 and the second rear opening portion 24 are both in the open state.

With reference to FIG. 9A, here, based on an instruction of the operation controller 16, the first rear opening portion 23 is in the open state as a result of the first opening-closing member 25 being brought into a horizontal state, and the second rear opening portion 24 is in the open state as a result of the second opening-closing member 26 being brought into a perpendicular state.

With reference to FIG. 9B, when the vehicle 10 travels, the traveling wind path 21 takes in traveling wind through the front opening portion 22. After the traveling wind has been blown toward the rear right in the traveling wind path 21, the traveling wind is discharged out of the vehicle through the first rear opening portion 23 and the second rear opening portion 24. For example, with reference to FIG. 9A, the traveling wind is discharged rearward out of the first rear opening portion 23, and the traveling wind is straightened at the rear of the vehicle body 11. Further, the traveling wind is discharged downward through the second rear opening portion 24, and thus it is possible to hold down powder dust that is blown up by the rear tire 14.

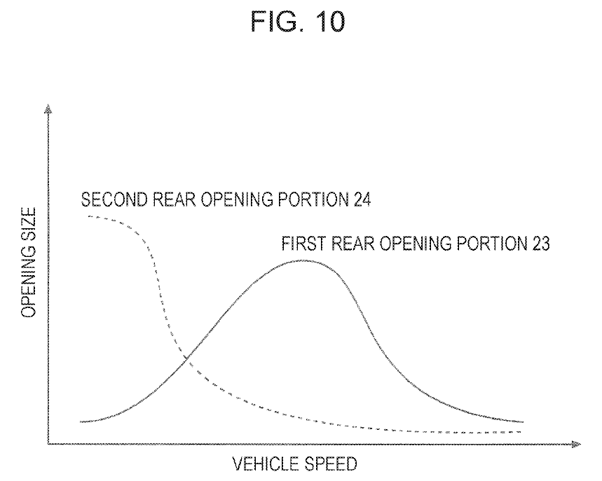

FIG. 10 is a graph illustrating characteristics of each traveling wind control device 20. In the graph, the horizontal axis indicates the vehicle speed of the vehicle 10, and the vertical axis indicates an opening size, that is, the opening degree (degree of opening) of each opening portion.

The degree of opening of the first rear opening portion 23 can be adjusted based on, for example, the travel speed of the vehicle 10. For example, with reference to FIG. 9A, as the vehicle speed of the vehicle 10 increases, the opening degree of the first rear opening portion 23 can be increased. Here, when the first opening-closing member 25 is brought close to the horizontal state, the opening degree of the first rear opening portion 23 is increased. In contrast, as the vehicle speed of the vehicle 10 increases, the opening degree of the first rear opening portion 23 can be decreased. Here, when the first opening-closing member 25 is brought close to a perpendicular state, the opening degree of the first rear opening portion 23 is decreased. In FIG. 10, as the speed of the vehicle 10 increases, the opening degree of the first rear opening portion 23 is increased until the speed of the vehicle 10 reaches a predetermined speed. In contrast, when the speed of the vehicle 10 exceeds the predetermined speed, as the speed of the vehicle 10 increases, the opening degree of the first rear opening portion 23 is decreased.

Similarly, the degree of opening of the second rear opening portion 24 can be adjusted based on, for example, the travel speed of the vehicle 10. For example, with reference to FIG. 9A, as the speed of the vehicle 10 increases, the opening degree of the second rear opening portion 24 can be increased. Here, when the second opening-closing member 26 is brought close to a perpendicular state, the opening degree of the second rear opening portion 24 is increased. In contrast, as the speed of the vehicle 10 increases, the opening degree of the second rear opening portion 24 can be decreased. Here, when the second opening-closing member 26 is brought close to the horizontal state, the opening degree of the second rear opening portion 24 is decreased. In FIG. 10, as the speed of the vehicle 10 increases, the opening degree of the second rear opening portion 24 is decreased.

By controlling the opening degree of the first rear opening portion 23 and the opening degree of the second rear opening portion 24 as illustrated in FIG. 10, it is possible to, when the vehicle 10 travels, effectively control underfloor flow, which is the flow of traveling wind below the vehicle lower portion 12. Therefore, it is possible to improve aerodynamic characteristics when the vehicle 10 travels.

The functions of each traveling wind control device 20 are as described above.

With reference to FIG. 2, the size and the aerodynamic performance of each opening portion are described. As described above, the traveling wind control device 20 includes the front opening portion 22, the first rear opening portion 23, and the second rear opening portion 24. The front opening portion 22 is an opening that takes traveling wind into the traveling wind path 21 from the outside. The first rear opening portion 23 and the second rear opening portion 24 are openings that discharge traveling wind to the outside of the vehicle through the traveling wind path 21.

Here, the front opening portion 22 is made larger than the first rear opening portion 23 and the second rear opening portion 24. This increases the speed of the traveling wind that is discharged to the outside of the vehicle through the first rear opening portion 23 and the second rear opening portion 24, controls the flow speed of the underfloor flow below the vehicle lower portion 12, and improves the aerodynamic performance of the vehicle 10.

Taking part of traveling wind into the traveling wind path 21 through the front opening portion 22 decreases the flow speed of traveling wind at the vehicle-width-direction intermediate portion below the vehicle lower portion 12. On the other hand, although, on the rear side of the rear tire 14, the rear tire 14 acts as an obstacle, the flow speed of the traveling wind can be increased by discharging high-speed traveling wind rearward out of the first rear opening portion 23. Therefore, the flow speed of the traveling wind on the rear side of the vehicle body 11 can be made uniform in the vehicle width direction. Thus, when the vehicle 10 travels, it is possible to, on the rear side of the rear tire 14, decrease swirling up of traveling wind, and improve aerodynamic performance.

Technical ideas that can be understood from the above-described embodiment together with their effects are described below.

A traveling wind control device according to an embodiment of the disclosure is configured to control a flow of traveling wind at a lower portion of a vehicle that travels. The traveling wind control device includes a traveling wind path, a front opening portion, a first rear opening portion, and a second rear opening portion. The traveling wind path is provided up to a rear side of a rear tire from a location situated inwardly of the rear tire in a vehicle width direction. The front opening portion is provided on a front end side of the traveling wind path. The first rear opening portion is provided on a rear end side of the traveling wind path and opens rearward. The second rear opening portion is provided on the rear end side of the traveling wind path and opens downward. According to the traveling wind control device of the embodiment of the disclosure, when the vehicle travels, causing the traveling wind to be blown rearward out of the first rear opening portion makes it possible to, on the rear side of the rear tire, increase the flow speed of the traveling wind and improve aerodynamic performance. When the vehicle travels, causing the traveling wind to be ejected downward out of the second rear opening portion makes it possible to suppress swirling up of powder dust caused by the rear tire that rotates and to suppress adhesion of dust to a rear window.

The traveling wind control device according to the embodiment of the disclosure further includes a vehicle-speed sensor, a first opening-closing member, a second opening-closing member, and an operation controller. The vehicle-speed sensor is configured to detect a travel speed of the vehicle that travels. The first opening-closing member has a structure that brings the first rear opening portion into an open state or a closed state. The second opening-closing member has a structure that brings the second rear opening portion into an open state or a closed state. The operation controller is configured to execute a first operation mode when the travel speed exceeds a predetermined threshold speed, and is configured to execute a second operation mode when the travel speed is less than or equal to the threshold speed. In the first operation mode, the operation controller is configured to bring the first rear opening portion into the open state by using the first opening-closing member, and is configured to bring the second rear opening portion into the closed state by using the second opening-closing member. In the second operation mode, the operation controller is configured to bring the first rear opening portion into the closed state by using the first opening-closing member, and is configured to bring the second rear opening portion into the open state by using the second opening-closing member. According to the traveling wind control device of the embodiment of the disclosure, when the vehicle travels at a high speed, the first operation mode is executed, and when the vehicle travels at a low speed, the second operation mode is executed. In the first operation mode when the vehicle travels at a high speed, causing the traveling wind to be blown rearward out of the first rear opening portion makes it possible to, on the rear side of the rear tire, increase the flow speed of the traveling wind and improve aerodynamic performance. In contrast, in the second operation mode when the vehicle travels at a low speed, causing the traveling wind to be ejected downward out of the second rear opening portion makes it possible to suppress swirling up of powder dust caused by the rear tire that rotates and to suppress adhesion of dust to a rear window.

In the traveling wind control device according to the embodiment of the disclosure, the operation controller is configured to change an opening degree of the first opening-closing member or an opening degree of the second opening-closing member based on the travel speed. According to the traveling wind control device of the embodiment of the disclosure, changing the opening degree of the first opening-closing member based on the travel speed makes it possible to change the speed of the traveling wind blown rearward out of the first rear opening portion. Similarly, changing the opening degree of the second opening-closing member based on the travel speed makes it possible to change the speed of the traveling wind blown downward out of the second rear opening portion.

In the traveling wind control device according to the embodiment of the disclosure, in the first operation mode, the operation controller is configured to decrease the opening degree of the first opening-closing member as the travel speed increases. According to the traveling wind control device of the embodiment of the disclosure, when the vehicle travels at a high speed, the speed of the traveling wind blown rearward out of the first rear opening portion can be increased due to the effect of a contraction of flow, and the speed of the traveling wind on a rear-direction side of the rear tire is increased and thus the aerodynamic performance can be improved.

In the traveling wind control device according to the embodiment of the disclosure, the first rear opening portion is disposed rearwardly of the second rear opening portion. According to the traveling wind control device of the embodiment of the disclosure, disposing the first rear opening portion on the rear side makes it possible to more effectively discharge high-speed traveling wind rearward out of the first rear opening portion. In addition, disposing the second rear opening portion close to the rear tire makes it possible to more effectively hold down, by the traveling wind that blows out of the second rear opening portion, the rising of powder dust that is blown up due to the rotation of the rear tire.

In the traveling wind control device according to the embodiment of the disclosure, the second rear opening portion is disposed below the first rear opening portion. According to the traveling wind control device of the embodiment of the disclosure, disposing the second rear opening portion on the lower side makes it possible to more effectively hold down, by the traveling wind that blows out of the second rear opening portion, the rising of powder dust that is blown up due to the rotation of the rear tire.

Although the embodiments of the disclosure have been described above, the disclosure is not limited thereto, and changes can be made within a scope that does not depart from the spirit of the disclosure. In addition, the forms described above can be combined with each other.

1. A traveling wind control device configured to control a flow of traveling wind at a lower portion of a vehicle that travels, the traveling wind control device comprising:
a traveling wind path;
a front opening portion;
a first rear opening portion; and
a second rear opening portion,
wherein the traveling wind path is provided up to a rear side of a rear tire from a location situated inwardly of the rear tire in a vehicle width direction,
wherein the front opening portion is provided on a front end side of the traveling wind path,
wherein the first rear opening portion is provided on a rear end side of the traveling wind path and opens rearward, and
wherein the second rear opening portion is provided on the rear end side of the traveling wind path and opens downward.

2. The traveling wind control device according to claim 1, further comprising:
a vehicle-speed sensor;
a first opening-closing member;
a second opening-closing member; and
an operation controller,
wherein the vehicle-speed sensor is configured to detect a travel speed of the vehicle ,
wherein the first opening-closing member has a structure that brings the first rear opening portion into an open state or a closed state,
wherein the second opening-closing member has a structure that brings the second rear opening portion into an open state or a closed state,
wherein the operation controller is configured to execute a first operation mode when the travel speed exceeds a predetermined threshold speed, and execute a second operation mode when the travel speed is less than or equal to the threshold speed,
wherein the operation controller is configured to, in the first operation mode, bring the first rear opening portion into the open state by using the first opening-closing member, and bring the second rear opening portion into the closed state by using the second opening-closing member, and
wherein the operation controller is configured to, in the second operation mode, bring the first rear opening portion into the closed state by using the first opening-closing member, and bring the second rear opening portion into the open state by using the second opening-closing member.

3. The traveling wind control device according to claim 2,
wherein the operation controller is configured to change one or both of an opening degree of the first opening-closing member and an opening degree of the second opening-closing member based on the travel speed.

4. The traveling wind control device according to claim 2,
wherein the operation controller is configured to, in the first operation mode, decrease the opening degree of the first opening-closing member as the travel speed increases.

5. The traveling wind control device according to claim 1,
wherein the first rear opening portion is disposed rearwardly of the second rear opening portion.

6. The traveling wind control device according to claim 1,
wherein the second rear opening portion is disposed below the first rear opening portion.
